(19) United States
(12) Patent Application Publication
(10) Pub. No.: US 2022/0016709 A1
(43) Pub. Date: Jan. 20, 2022

(54) A DEVICE FOR REMOVING FLAWS IN SITU DURING THE ADDITIVE PRINTING OF METAL PARTS

(71) Applicant: POLITECNICO DI MILANO, Milano (IT)

(72) Inventors: Bianca Maria COLOSIMO, Milano (IT); Barbara PREVITALI, Milano (IT); Marco Luigi Giuseppe GRASSO, Milano (IT); Ali Gokhan DEMIR, Milano (IT); Eligio Gianni GROSSI, Milano (IT)

(73) Assignee: POLITECNICO DI MILANO, Milano (IT)

(21) Appl. No.: 17/295,540

(22) PCT Filed: Nov. 27, 2019
(86) PCT No.: PCT/IB2019/060221

§ 371 Date: May 20, 2021

(30) Foreign Application Priority Data
Nov. 27, 2018 (IT) 102018000010598

(51) Int. Cl. B22F 10/38; B22F 3/24; B22F 10/85

(52) U.S. Cl. CPC B22F 10/38; B22F 3/24; B33Y 10/00; B22F 2003/247; B22F 2998/10; B22F 10/85

(57) ABSTRACT

A device for removing flaws in situ during the additive molding of metal parts forms the subject of the invention. The device comprises: a hopper adapted to contain metal powder; a printing platform, sliding along an axis; a metal powder releasing device, to allow the powder to fall from the hopper onto the printing platform; a doctor blade for distributing the powder onto the printing platform, forming a bed of powder; a laser source and associated laser beam scanning system, for selectively melting the bed of powder; a grinder for removing flawed layers and a monitoring system, configured to detect possible flaws in the layers, wherein said monitoring system is connected to an electronic control unit, configured to activate the aforesaid grinder in order to remove the flaws detected by the monitoring system.

### FIELD OF THE INVENTION

The invention relates to a device for removing flaws in situ from parts made by means of 3D printing techniques.

### PRIOR ART

Devices are known, which, when integrated with 3D printing systems, can intervene, in some way, on flaws and/or couple treatments of a various nature into the system itself.

For example, the process is known, described in the following document: [A] Moog Inc., East Aurora, N.Y. (US)., Gregory Thomas Mark, Cambridge, Mass. (US), “METHOD FOR LAYER-BY-LAYER REMOVAL OF DEFECTS DURING ADDITIVE MANUFACTURING”, Appl. Filed.: Mar. 2, 2017, Appi. No.: PCT/US15/45658. This document proposes a method of coupling between a powder bed process and a swarf removal process. The object of the swarf removal consists of applying a finishing to the outer and inner walls of the printed part, layer after layer, in order to obtain, at the end of the printing, the part with an already elevated surface finishing.

As regards the method, the aforesaid patent comprises an action of micro-removal for the surface finishing of the walls of the part. An entire removal of the layer is not comprised and the consequent treatment for resuming the printing from the preceding layers.

Furthermore, the method stated in the above document is not intended for removing layers containing flaws, but only for finishing the surfaces of the part. The term “flaws” is used in the patent to indicate surface and sub-surface irregularities, which would normally be removed during post-process finishing processes and which, instead, due to this method, could even be removed during the printing.

A second known document is: [B] MARKFORGED, INC., Cambridge, Mass. (US), Jason C. Jones, Buffalo, N.Y. (US); Ian L. Brooks, Gloucester (GB), “MOLTEN METAL JETTING FOR ADDITIVE MANUFACTURING”, Appl. Field.: Sep. 26, 2016, Appi. Ser. No. 15/275,849.

This document states the possibility of using a correction process for the leveling, layer after layer, of the surface deposited during metal jetting processes.

Metal jetting technology is described in relation to the process.

A leveling of the surface deposited may be necessary in metal jetting processes and the document proposes the use of a grinder for such object. Thus, the grinder is not used to remove one or more layers, nor to remove flaws, but to obtain a layer with a surface finishing and homogeneity (in terms of topography), which are such that they improve the adhesion between layers and improve the accuracy of the process.

With regard to removing, or correcting flaws, in-situ, there are only few jobs, which principally propose surface treatment techniques (ablation or re-melting) of the final printed layer using the same laser system used for the Selective Laser Melting (SLM) process.

These are the following studies:
[1] Mireles, J., Ridwan, S., Morton, P. A., Hinojos, A., & Wicker, R. B. (2015a). Analysis and correction of defects within palls fabricated using powder bed fusion technology. Surface Topography: Metrology and Properties, 3(3), 034002.
[2] Yasa, E., Kruth, J. P., & Deckers, J. (2011). Manufacturing by combining selective laser melting and selective laser erosion/laser re-melting. CIRP Annals-Manufacturing Technology, 60(1), 263-266.

The elevated cost of the metal powders and the lengthy printing times mean that the high levels of defectiveness of the current systems on the market have a considerable impact on the financial and productive sustainability of 3D metal printing.

If a flaw is detected, the only solution currently available, if the flaw is detected along the line, consists of interrupting the process and discarding the part.

This has a considerable impact on production costs, productivity and sustainability of the technology.

From an analysis of the literature, few studies exist, reported previously, which propose techniques to remove or mitigate the flaw along the line according to the laser powder bed fusion technique (LPBF), and they are based on thermal surface treatments obtained through laser erosion or re-melting.

However, this strategy is mainly aimed at reducing internal porosity, but it doesn't allow other types of flaws to be corrected, for example, flaws of a geometric type in the plane or outside the plane (so-called super-elevated edges).

It is an object of the present invention to develop a system capable of removing process flaws during the application of the laser powder bed fusion technique (LPBF) with metal parts.

It is a further object of the present invention to create a process, which has a wider range of action than that currently present in the art and which allows the removal of flaws, which cannot be removed in any other way.

### BRIEF SUMMARY OF THE INVENTION

Thus, the present invention aims to achieve the above objects by means of a device for removing flaws in situ, said device comprising:
a hopper adapted to contain metal powder;
a printing platform sliding along an axis;
a powder releasing device to allow the powder to fall from the hopper onto the printing platform; the powder releasing device can be made, for example, by means of a vibrating foil.
a doctor blade for distributing the powder onto the printing platform, forming a bed of powder;
a laser source and a laser beam scanning system associated with said laser source for the selective melting of the bed of powder; characterized in that it further comprises:
a grinder for removing flawed layers; and
a monitoring system configured to detect possible flaws in the layers, wherein said monitoring system is connected to an electronic control unit configured to activate the aforesaid grinder in order to remove the flaws detected by the monitoring system.

One advantage of such embodiment comes from the fact that it allows a first-time-right production, thus reducing costs and time-to-market, also for complex and personalized products.

According to one embodiment of the invention, the grinder is mounted onto a grinder cart, which allows a longitudinal feeding movement of the grinder.

According to one embodiment of the invention, the monitoring system comprises at least one sensor, configured to inspect a melted pool of material in the bed of powder.

According to another embodiment of the invention, the monitoring system comprises at least one sensor outside the optical path of the laser source.

According to a further embodiment of the invention, the monitoring system comprises at least one camera configured to detect the geometry and surface pattern of the entire printing area.

The invention also comprises a method for removing flaws in situ carried out using the described device, wherein the method comprises the following steps:
using the monitoring system to monitor the possible presence of flaws in the layers to be treated;
in the event of detecting at least one flaw in the last layer treated, mutually displacing the printing platform and the grinder so as to allow contact between the grinder and the upper layer of the part treated;
carrying out a correction step by means of contact between the grinder and the upper layer,
carrying out a thermal surface treatment using the laser source of the device so as to obtain a surface pattern and a surface condition adapted to resume the method of removing flaws in situ, and
resuming the method of removing flaws in situ.

Further features of the invention can be drawn from the dependent claims.

### BRIEF DESCRIPTION OF THE FIGURES

Further features and advantages of the invention will be clearer in the light of the following detailed description with the aid of the accompanying drawing tables, wherein:

FIG. 1 schematically illustrates a device for removing flaws, in situ, for metal parts according to one embodiment of the invention;

FIG. 2 is a view from above of the device in FIG. 1;

FIG. 3 illustrates a summary outline of the different levels of monitoring, which can be used to recognize flaws in situ;

FIG. 4 illustrates a device for removing flaws in situ according to one embodiment of the invention; and

FIG. 5 illustrates a device for removing flaws, in situ, according to one embodiment of the invention.

### DETAILED DESCRIPTION OF VARIOUS EMBODIMENTS OF THE PRESENT INVENTION

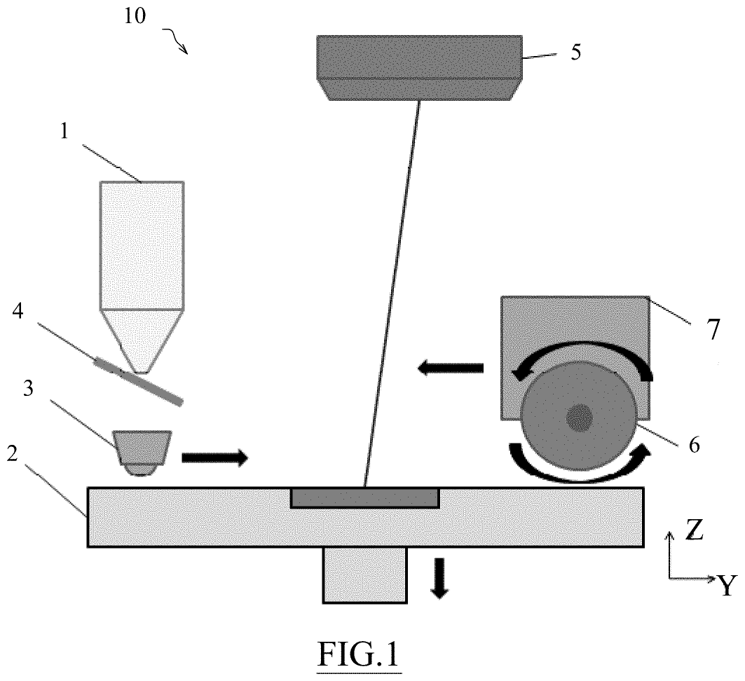

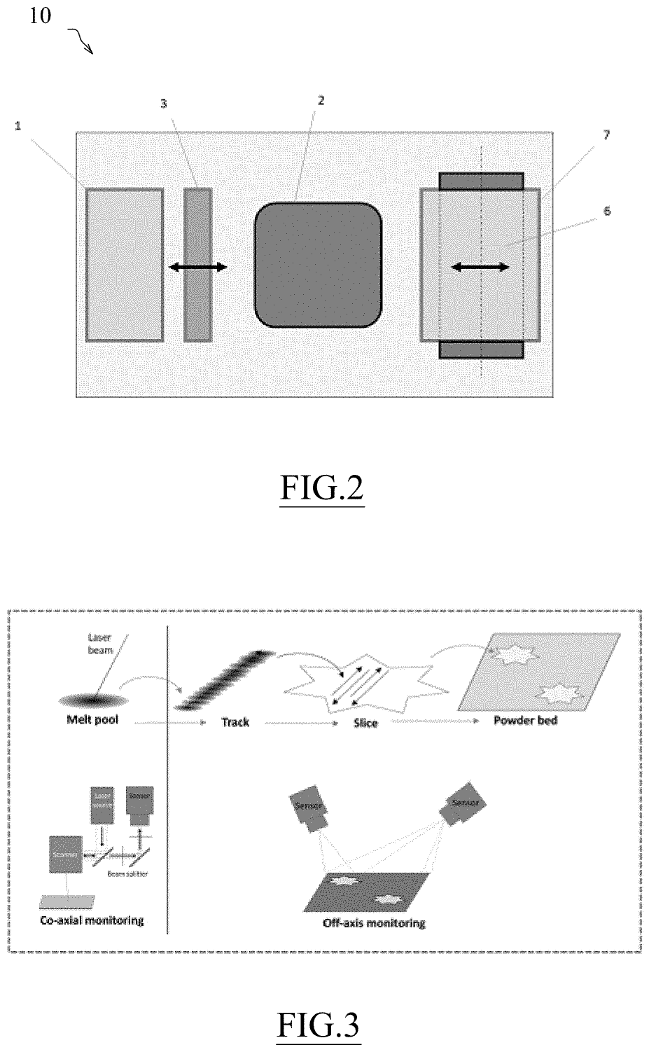

The invention will now be described with initial reference to FIG. 1 (and to FIG. 2), which schematically illustrates a device for removing flaws, in situ, in metal parts according to one embodiment of the invention, globally denoted with numeral reference 10.

The device 10 comprises a hopper 1 adapted to contain metal powder and a printing platform 2 sliding along an axis.

The metal substrate is installed on the platform 2, on which the powder is deposited and the printing process is carried out through selective melting by means of a laser source 5, in particular, according to the laser powder bed fusion technique (LPBF).

The platform 2 slides along the axis z, indicated in FIG. 1, with steps equal to the thickness of the preset layer.

The device 10 further comprises a powder releasing device 4, to allow the powder to fall, from the hopper 1, onto the printing platform 2 of the work plane and a doctor blade 3 for distributing the powder on the printing platform 2 of the work plane, as well as a laser source 5 associated with an opportune laser beam scanning system, for selectively melting the bed of powder.

According to an innovative aspect of the invention, the device further comprises a grinder 6, which is used for the removal, by means of longitudinal correction, of the flawed layers.

The grinder 6 can have a surface texture, which is such that it obtains a finishing and surface texture adapted to continue the LPBF process downstream of the removal.

In turn, the grinder 6 is mounted onto a grinder cart 7, which allows the longitudinal feeding movement of the grinder 6.

As illustrated in greater detail below, the grinder 6 is used for removing flawed layers.

Finally, the device 10 comprises a monitoring system 8, configured to detect possible flaws in the layers, wherein said monitoring system 8 is connected to an electronic control unit 12, which is configured, in turn, to activate the grinder 6 in order to remove the flaws detected by the monitoring system 8.

The previously described printing and removal systems act in a sealed work chamber 15, in a controlled atmosphere, inside which the percentage of oxygen is reduced through one or more no-load washes, which precedes the printing and successive supply of insert gas (argon or other insert gases), which is kept in slight overpressure for the entire duration of the process, for example, all by means of an opportune system of recirculating 160 the inert gas and environmental control in the work chamber 15.

The device 10 is also equipped with a system of different types of sensors for monitoring the process and for identifying the flaw in-situ and for actuating the system of removing the flawed layers.

In general, the recognition of flaws along the line can be obtained by observing different process marks (measurable quantities in-situ) and with different types of sensors.

FIG. 3 shows three different levels of monitoring in terms of measurable quantities.

The first level of monitoring concerns the melted pool, i.e. the zone of the bed of powder, in which the selective melting of the material is carried out; this zone has a diameter in the order of a few hundred microns and moves at the scanning speed of the laser. The shape, size and intensity of the melted pool represent important process stability indicators, but in order to be measured, they require an elevated spatial and temporal resolution. The most suitable measurement method consists of using sensors (e.g., photodiodes or cameras in the visible or infrared range), positioned co-axially to the optical path of the laser. This type of measurement set-up takes the name of co-axial monitoring. The observation of a local instability in the melted pool in terms of size, shape or intensity is an indicator of a flaw and, if detected along the line, can allow the signaling of an alarm and the corrective action to be activated.

The second level of monitoring concerns the sizes, which can be measured along each scanning line. In this case, the field of view must be wider than the field of view which can be obtained with a co-axial sensor and, thus, it is possible to use sensors outside the optical path of the laser (off-axis monitoring). The quantities which can be measured in this way include both local overheating (called hot-spots) due to non-corrected thermal exchanges and the consequent formation of local flaws, and process instabilities linked to the formation of sparks and vaporization of the material (plumes). High-speed cameras in the visible or infrared allow such anomalies to be detected and the presence of flaws along the line to be signaled, with the consequent activation of the corrective action.

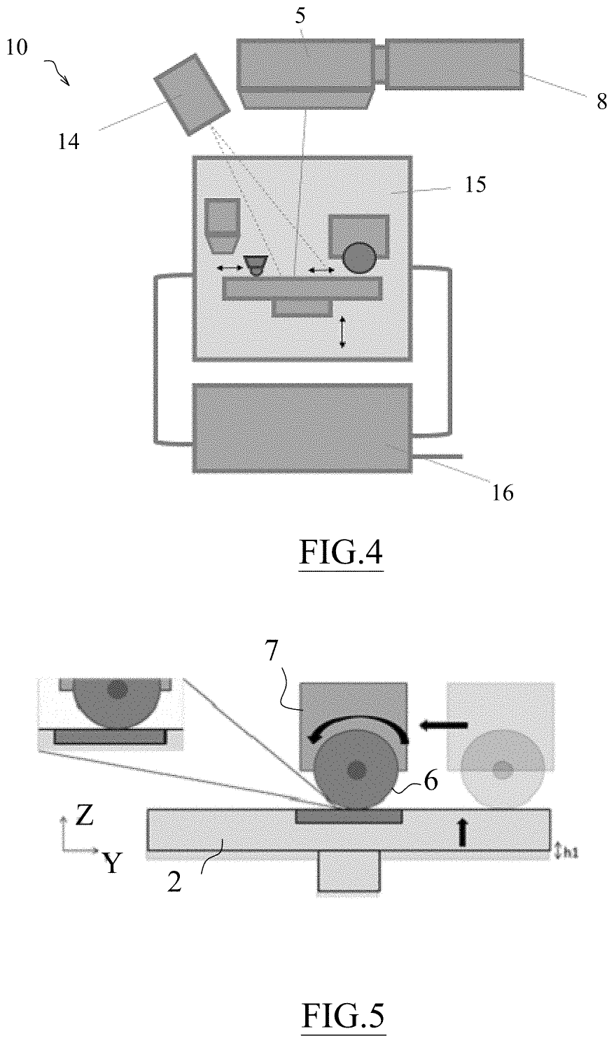

The last level of monitoring concerns the entire printed surface and/or the entire surface of the bed of powder. In this case, the use of high spatial resolution cameras allows the reconstruction of the geometry and surface pattern of the printed area, to detect flaws of the geometric or surface type (in the plane of the bed of powder or outside the plane), for example, linked to powder covering errors or local energy densities, which are too high or too low. In this case, too, it is possible to identify flaws automatically from an analysis along the line of the images acquired, layer after layer and activate the corrective action. The configuration of the system prototype for removing flaws along the line described herein includes the option of simultaneously installing different types of sensors due to three openings on the roof of the work chamber (FIG. 4) and to the accessibility of the optical path of the laser. The number of openings can be increased according to the volume of the prototype.

The following is an example of a sensorized configuration:
Off-axis camera 14 with high spatial resolution, which acquires a photo for each layer, for detecting surface and geometric flaws in the bed of powder;
High-speed off-axis camera in the visible range for monitoring hot-spots and sparks;
Off-axis (infrared) thermographic camera for monitoring the thermal map of the process, sparks and plumes;
Photodiodes and possible co-axial camera in the nearby high-speed infrared for monitoring the melted pool.

Various studies have already been published by researchers involved in this patent relating to the development of statistical analysis techniques for the automatic detection of flaws during the LPBF process with various sensorization strategies, described above, the list of which is reported at the end of the present description.

Described below is the working of the printing system and removal of the flaw along the line.

First, the working is described in the absence of flaws:

A1. The work plane is translated downwards along the axis Z by a height equal to the thickness of the layer of powder, which is desired to be spread on the work plane (thickness preset layer).

A2. The powder releasing device is actuated. This allows the exit of the powder from the opening of the hopper and the fall thereof onto the work plane at the doctor blade.

A3. The doctor blade moves from the starting position to the end stop positioned at the opposite end of the work plane, so as to distribute the metal powder evenly over the work plane.

A4. The laser is activated and selectively melts the bed of powder, following a path, predetermined in the design step.

A5. Once the laser has finished the scan, the doctor blade returns to the starting position.

This process is repeated a number of times equal to the number of layers to be printed, necessary to complete the entire part.

Now the working will be described in the case of identification of a flaw along the line.

If a flaw is identified in the current layer, at the end of step A5, described above, proceed as follows:

B1. Advancing of the axis Z.

the axis z is moved upwards with a displacement of the printing platform 2 equal to a height h1, which is such that it allows contact between the grinder and upper layer of the printed part (FIG. 5, which illustrates a diagram of the advancing of the axis z).

B3. Correction.

After regulating the contact between the grinder and the upper layer by means of an opportune contact detection system, a correction is made in several passes. At the end of each pass, the axis Z is translated upwards by a height equal to the desired pass depth for the single pass. The total depth of material removed is a parameter to be defined beforehand.

B4. Distancing of the work plane from the grinder.

After carrying out the removal, the axis Z and the work plane are brought into such a position that it is possible to resume the printing, taking into consideration the thickness of the material removed.

B5. Softening surface treatment.

Before resuming the process, a thermal surface treatment is carried out on the area, in which the removal of the layer was applied. Such treatment exploits the same laser source used for the LPBF process, and has the object of improving the adhesion of the successive layer of material added by selective melting, and minimizing the discontinuity caused by the removal of material.

B6. Resuming the LPBF process.

The LPBF process is resumed, starting normally, if necessary, with a correction of the process parameters, which is such that it avoids the flaw from being formed again.

In summary, the present method operates in the following way.

1) The process monitoring system based on in-situ sensors (for example, high-speed cameras or thermographic cameras) signals the presence of a flaw in the last layer made;

2) The grinder cart is activated and removes the final layers printed, in one or more passes;

3) A thermal surface treatment is carried out using the same laser source used for the LPBF process so as to obtain a finishing and a surface layer suitable for resuming the printing and for minimizing the discontinuity caused by the removal of the swarf. The object is to obtain a greater adhesion of the printed part on the part processed by the grinder due to the softening thermal treatment. If necessary, it is possible to use a grinder with a non-random surface texture, to reproduce a roughness on the surface in the range of that produced by the LPBF process, as well as a pattern, which is such as to improve the adhesion between successive layers and minimize discontinuities.

4) The LPBF process is resumed, if necessary, with process parameters adapted to avoid the flaw from forming again.

Thus, the invention differs considerably from the hybrid systems (additive and subtractive), already present on the market because the subtractive technology is not used for the in-situ finishing of the internal and external surfaces of the printed part (as is the case in some commercial systems), but to remove layers, which contain flaws identified during the process.

This requires the coupling of a system for removing swarf by means of correction with a surface laser treatment to minimize the discontinuity caused by the removal.

### INDUSTRIAL APPLICABILITY

The field of application of the invention is advanced manufacturing, aimed at producing parts with high added value and innovative solutions. In particular, the context of the invention regards the additive printing of metal with powder bed processes, which represents a technology capable of revolutionizing production systems and which is already a reality in many sectors (for example, aerospace and biomedicine).

All of the main developers of LPBF systems (e.g., EOS, Renishaw, SLM Solutions, etc.) are investing in the sensorization of machines and in new methods of process monitoring to recognize flaws during the process, reduce waste and integrate post-process quality controls with in-situ analyses and measures.

However, the systems available on the market still do not have an intelligence integrated into the system, aimed at the automatic identification of flaws and the removal thereof.

The technology developed allows such gap to be filled and can thus be applied by producers of powder bed additive systems for metal (upgrade of existing systems or completely new machine configurations). The advantages offered are of particular interest to end users in sectors characterized by stringent quality constraints: primarily, aerospace and medicine, as well as tooling & molding and the creative and automotive industry.

Clearly, modifications or improvements can be made to the invention thus described without thereby departing from the scope of the invention as claimed below.

### FURTHER RELEVANT DOCUMENTS

[1] Colosimo, B. M., Grasso, M. (2018), Spatially weighted PCA for monitoring video image data with application to additive manufacturing, Journal of Quality Technology, 50(4), doi:10.1115/1.4041709
[2] Grasso, M., Demir, A. G., Previtali, B., Colosimo, B. M. (2018), In-situ Monitoring of Selective Laser Melting of Zinc Powder via Infrared Imaging of the Process Plume, Robotics and Computer-integrated Manufacturing, 49, 229-239. https://doi.org/10.1016/j.rcim.2017.07.001
[3] Repossini G., Laguzza V., Grasso M., Colosimo B. M., (2018), On the use of spatter signature for in-situ monitoring of Laser Powder Bed Fusion, Additive Manufacturing, 16, 35-48. https://doi.org/10.1016/j.addma.2017.05.004.
[4] Grasso M., Laguzza V., Semeraro Q., Colosimo B. M., (2017), In-process Monitoring of Selective Laser Melting: Spatial Detection of Defects via Image Data Analysis, Journal of Manufacturing Science and Engineering, 139(5), 051001-1-051001-16.
[5] Caltanissetta F., Grasso M., Petrò S., Colosimo, B. M. (2018). Characterization of In-Situ Measurements based on Layerwise Imaging in Laser Powder Bed Fusion, Additive Manufacturing, 24, 183-199
[6] Grasso M., Colosimo B. M., (2017), Process Defects and In-situ Monitoring Methods in Metal Powder Bed Fusion: a Review, Measurement Science and Technology, 28(4), 1-25, DOI: 10.1088/1361-6501/aa5c4f

What is claimed is:

1. A device for removing flaws in metal parts, in situ, said device comprising:
a hopper adapted to contain metal powder;
a printing platform sliding along an axis;
a powder releasing device to allow the powder to fall from the hopper onto the printing platform;
a doctor blade for distributing the powder onto the printing platform forming a bed of powder;
a laser source for selectively melting the bed of powder; and the device further comprises:
a grinder for removing flawed layers; and
a monitoring system configured to detect possible flaws in the layers, wherein said monitoring system connected to an electronic control unit configured to activate the aforesaid grinder in order to remove the flaws detected by the monitoring system.

2. The device according to claim 1, wherein the grinder is mounted onto a grinder cart, which allows a longitudinal feeding movement of the grinder.

3. The device according to claim 1, wherein the monitoring system comprises at least one sensor configured to inspect a melted pool of material in the bed of powder.

4. The device according to claim 1, wherein the monitoring system comprises at least one sensor outside the optical path of the laser source.

5. The device according to claim 1, wherein the monitoring system comprises at least one camera configured to detect the geometry and surface pattern of the entire printing area.

6. A method for removing flaws in situ, carried out using the described device, wherein the method comprises the following steps:
using the monitoring system for monitoring the possible presence of flaws in the layers to be treated;
in the event of detecting at least one flaw in the last layer treated, mutually displacing the printing platform and the grinder so as to allow contact between the grinder and the upper layer of the part treated;
carrying out a grinding step by contacting the grinder with the upper layer,
carrying out a thermal surface treatment using the laser source of the device
so as to obtain a surface pattern and a surface condition adapted to resume the method of removing flaws in situ, and
resuming the method of removing flaws in situ.

7. The printing method according to claim 6, wherein the grinding step is carried out in several passes, wherein, at the end of each pass, the printing platform is translated upwards by a height equal to the desired pass depth for the single treatment.

8. The printing method according to claim 6, wherein the step of resuming the method of removing flaws in situ is carried out using corrected process parameters to avoid the flaw detected from being formed again.
